(19) United States
(12) Patent Application Publication
(10) Pub. No.: US 2003/0036983 A1
(43) Pub. Date: Feb. 20, 2003

(54) Method for inventory and layout management of a facility

(76) Inventors: Jerome L. Hougen, Wylie, TX (US); Allen D. Peterson, Garland, TX (US)

Correspondence Address: BAKER BOTTS L.L.P., 2001 ROSS AVENUE, SUITE 600, DALLAS, TX, 75201-2980, US

(21) Appl. No.: 10/212,522

(22) Filed: Aug. 5, 2002

Related U.S. Application Data
(60) Provisional application No. 60/312,592, filed on Aug. 14, 2001.

(51) Int. Cl. G06F 17/60

(52) U.S. Cl. 705/28

(57) ABSTRACT

A method for generating inventory data for a facility and for managing the configuration of a facility layout comprises creating a database of information defining the facility and the layout of any fixtures, equipment, equipment racks and systems and also creating a database of information defining any of the fixtures, equipment, equipment racks and systems in the facility. Generating the inventory data further comprises assigning identification information to the defined fixtures, equipment, equipment racks and systems to create an identification base, and storing the created databases in one or more memory locations of a computer network. Managing the configuration of a facility layout comprises visualizing a facility for configuration management utilizing the created one or more databases and selecting from the one or more databases fixtures, equipment, equipment racks and systems for managing the layout configuration of the visualized facility. The fixtures, equipment, equipment racks and systems selected from the created one or more databases are visualized in a layout configuration of the facility.

### RELATED APPLICATION

This application claims the benefit of U.S. provisional application Serial No. 60/312,592, filed Aug. 14, 2001, entitled A Method for Inventory and Layout Management of a Facility.

### TECHNICAL FIELD OF THE INVENTION

This invention relates to a method for inventory management and more particularly to managing the configuration of a facility layout from the inventory management.

### BACKGROUND OF THE INVENTION

Industrial organizations are often faced with the need to relocate facilities or reconfigure existing facilities as a result of business expansion or relocation based on economic factors. Where an industrial facility includes an extensive array of fixtures, equipment, equipment racks and systems, the relocation effort requires considerable time and expense and many times results in loss production and loss revenues. Industry representatives have long struggled with relocation problems and most of the presently used techniques utilize manual inventory tracking and relocating of fixtures, equipment, equipment racks and systems.

Current inventory and configuration management methods are oriented toward a text only description of the fixtures, equipment, equipment racks and systems utilizing manually prepared facilities illustrations. As expected, for a large industrial complex having multiple facilities, these text only descriptions result in large and cumbersome reports and in some cases are printed in book form. This results in considerable investigative time to review these large reports or printed books to identify fixtures, equipment, equipment racks and systems for location and installation in a facility of interest. Although the reports and books do contain an index locating a particular item this is time consuming and in many cases subject to error inasmuch as the only description was in the form of a text.

Other inventory and layout management techniques are based on databases stored in a proprietary computer network. However, these earlier database techniques still relied on a text description and were primarily text oriented. To create the inventory database required manual entry by means of a computer keyboard or with some techniques a form of barcode reader was utilized to enter the necessary data about an object being inventoried into a database. Although utilizing computer technology, a user attempting to inventory and layout a facility relied only on a text description of the fixtures, equipment, equipment racks and systems. Not only did these earlier techniques require considerable time and effort it was also difficult in many situations to accurately track the movement of the items to be relocated from one facility to another facility. In addition, the layout of fixtures, equipment, equipment racks and systems to a facility to be occupied was a trial and error manual process that often resulted in equipment and equipment racks being erroneously located and poorly managed in location. Further, the interconnecting of the various fixtures and equipment using under floor trays was a manual operation resulting in many misconnections.

### SUMMARY OF THE INVENTION

In accordance with the present invention, a method for managing and the configuration of a facility layout utilizes text displayed on a computer monitor along with pictorial information in a web browser or over an intranet utilizing point and click inputs.

Further in accordance with the present invention, there is provided a method for inventorying a facility, including fixtures, equipment, equipment racks and systems utilizing AutoCAD drawings and photographs of an object or area along with a text description for subsequent use in graphic displays to manage the layout of a facility. The method of the present invention enables use of the drawings, photographs and text to enable a user to investigate the details of information about fixtures, equipment, equipment racks and systems and as required, additional text description or graphics of detailed information. The method of the present invention provides users with a visual means of pictures and words displayed within a browser such as Netscape Navigator or Microsoft Internet Explorer to describe the inventory and configuration of a facility with regards to equipment installed, location of the equipment and cabling to and from the equipment racks. In addition the method of the present invention links relevant documents that can be put online within one or more of the databases available in a computer network.

Also, in accordance with the present invention, there is provided a method for managing the configuration of a facility layout, comprising creating a database defining the facility, fixtures, equipment, equipment racks and systems. The facility of interest is visualized so as to enable configuration of the facility utilizing the created database. Based on the visualization of the facility the user selects fixtures, equipment, equipment racks and systems from the created database. The selected items are also illustrated to enable managing the layout configuration of a facility.

A user of the method of the present invention selects the level of detail for illustrating the fixtures, equipment, equipment racks and systems all from the created database. Having a visualization of the facility of interest along with an illustration of the selected items, a user is able to position one or more of the items in the visualized facility.

Also in accordance with the present invention, a method for generating data defining a facility, including fixtures, equipment, equipment racks and systems comprises defining a facility and the layout of any fixtures, equipment, equipment racks and systems to create a facilities database of information defining the facility. Any of the fixtures, equipment, equipment racks and systems in the facility are defined to create a database of item information. Identification information is assigned to the defined fixtures, equipment, equipment racks and systems to create an identification database. The items are defined down to the level of detail necessary to fully inform a user of the details. Further, the method of the present invention comprises defining floor tile for supporting any of the fixtures, equipment, equipment racks and systems in the defined facility to create a floor tile database. Each of the created databases comprising either one or a plurality of databases is stored in one or more memory locations of a computer network.

A technical advantage of the present invention enables a user to view a visual representation of a facility and further the user has the ability to drill down to a desired level of detail, utilizing point and click, for the various fixtures, equipment, equipment racks and systems starting with a floor layout. The user drills down to the system level, then to the equipment rack level and then down to the component level. Various views of the fixtures, equipment, equipment racks and systems located in a facility are represented with AutoCAD drawings, digital photographs and/or text.

### BRIEF DESCRIPTION OF THE DRAWINGS

For a more complete understanding of the present invention and advantages thereof, reference is now made to the following description taken in conjunction with the accompanying drawings:

FIG. 1 is a block diagram of a computer network for inventory and layout management of a facility in accordance with the present invention;

FIG. 2 is a flowchart for creating inventory databases defining equipment, fixtures, system functions, manufacturer and model numbers for an existing facility;

FIG. 3 is a flow diagram of a method for managing the layout of selected equipment units in a facility of interest;

FIG. 4 is an illustration of a monitor display for a switchboard form used to start the data entry in accordance with the method of the present invention;

FIG. 5 is an illustration of a monitor display for defining a facility containing equipment to be inventoried;

FIG. 6 is an illustration of a monitor display for a barcode entry form for identification of fixtures, equipment, equipment racks and systems for creating an inventory database;

FIG. 7 is an illustration of a monitor display of a form for defining a new equipment rack for managing and laying out a facility of interest;

FIG. 8 is an illustration of a monitor display of a form for identifying information for defining a piece of equipment either in a rack or standalone;

FIG. 9 is an illustration of a monitor display of a form for inputting data identifying equipment and manufacturer information of fixtures and equipment;

FIG. 10 is an illustration of a monitor display of a form for providing additional input data to define equipment in a created database;

FIG. 11 is an illustration of a monitor display of a form for inputting subsystem information into a created database;

FIG. 12 is an illustration of a monitor display of a form for inputting information into a created database defining floor tiles for equipment layout and installation;

FIGS. 13a through 13e are views of various equipment photographs for editing and scanning into a created database;

FIG. 14 is an illustration of a monitor display of a form for inputting information into a created database defining cable ends at equipment;

FIG. 15 is an illustration of a monitor display of a form for inputting information into a created database defining cable ends for inventoried equipment;

FIG. 16 is an illustration of a monitor display showing an AutoCAD drawing of cable and cable pin identifiers;

FIG. 17 is an illustration of a monitor display of a top level browser view of a facility layout;

FIG. 18 is an illustration of a monitor display showing a system view, system racks and cable trays under a raised floor;

FIG. 19 is an illustration of a monitor display showing a front view of an equipment rack and an associated floor tile with cable cutouts;

FIG. 20 is an illustration of a dynamically generated equipment rack using equipment photographs as illustrated in FIGS. 13a through 13e;

FIG. 21 is an illustration of a monitor display showing equipment specific information and links to websites of manufacturers;

FIG. 22 is an illustration of a monitor display of a form showing a cable to/from lists extracted from a created database; and

FIG. 23 is an illustration of a monitor display of a form for online ordering of parts and equipment.

### DETAILED DESCRIPTION OF THE INVENTION

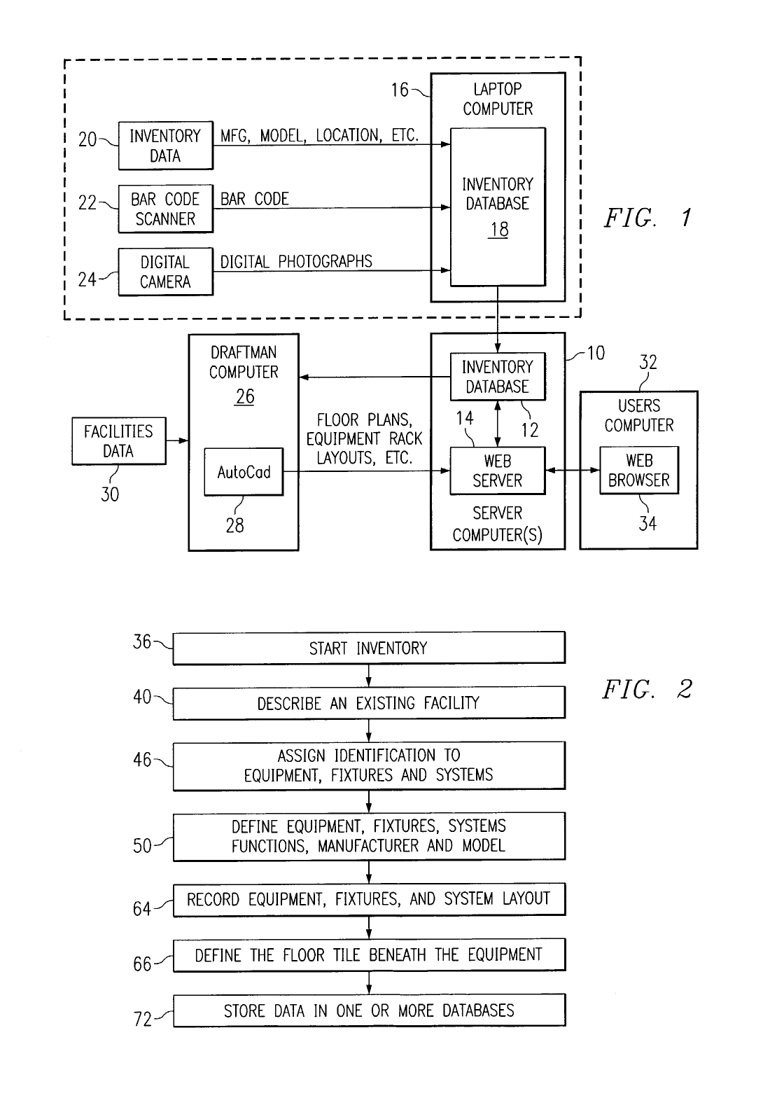

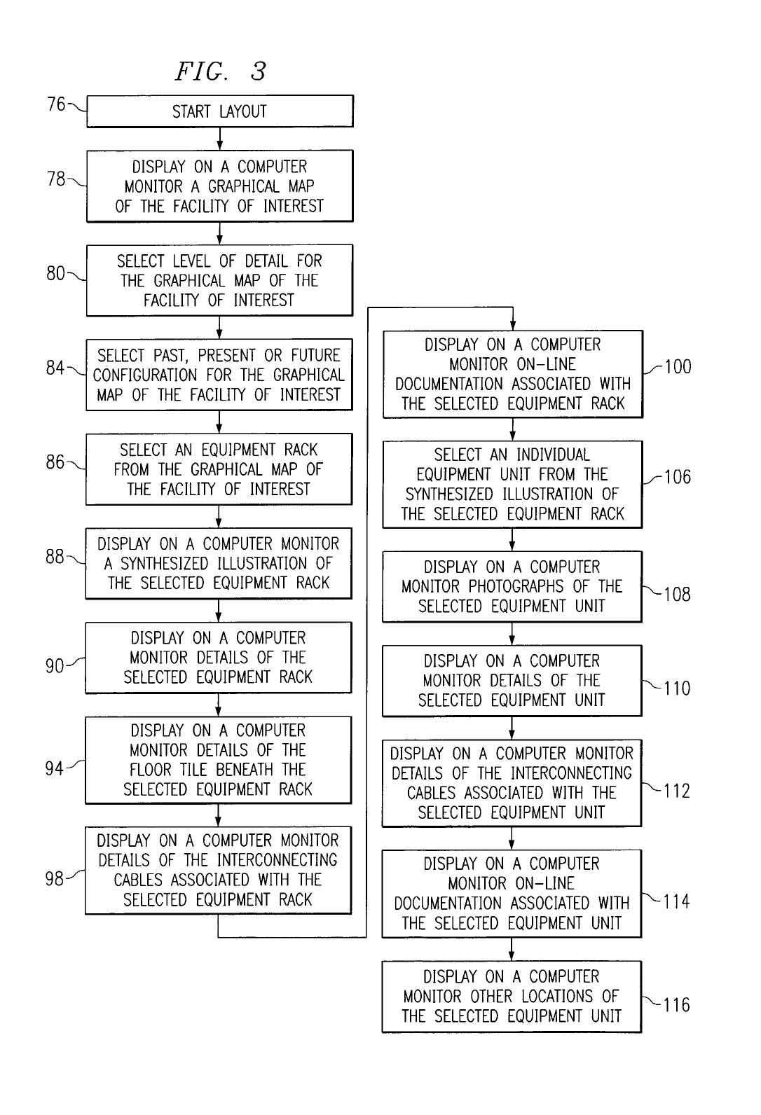

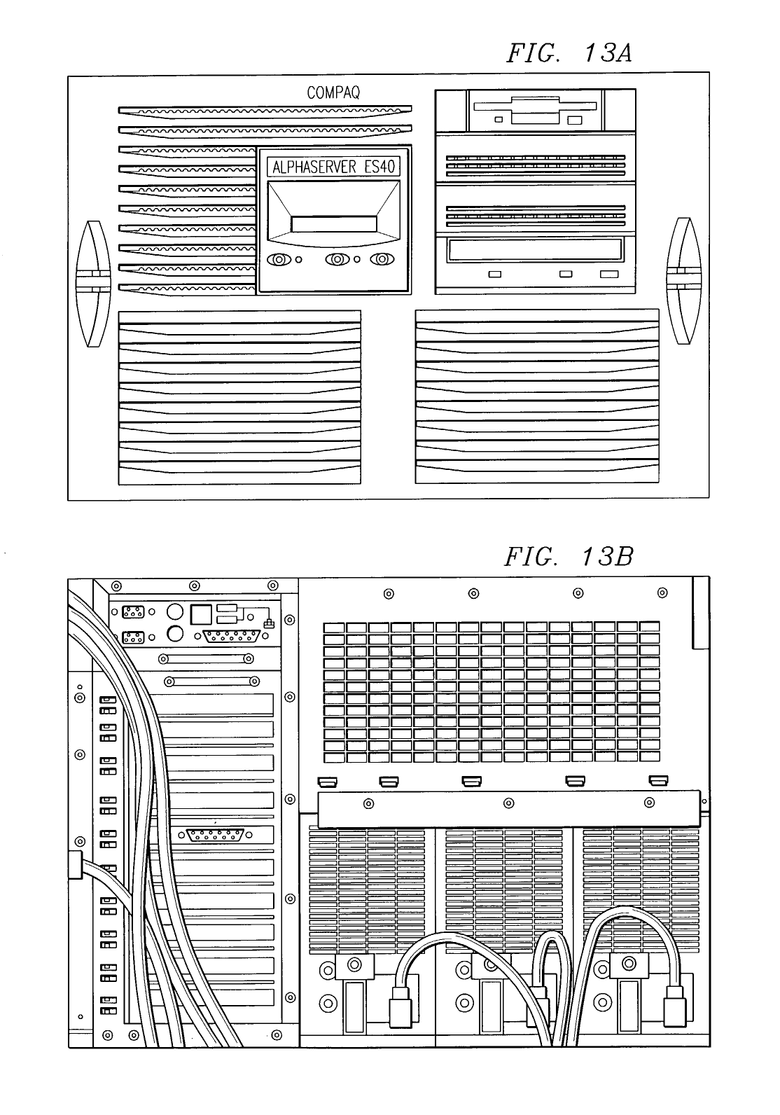

Referring to FIG. 1, there is illustrated a block diagram of a computer network for creating inventory databases and layout the configuration of a facility with regards to equipment installed, the location of the equipment, the cabling to and from the equipment and links to any relevant documents that are available for online access from within a database. The computer network comprises one or more server computers 10 (only one shown), each server computer having one or more inventory databases 12 and a web server 14. The server computer 10 is part of a local area network that comprises one or more laptop computers 16, each having a local inventory database 18. Each of the laptops computer 16 (only one shown but the network is not limited to only one) is coupled to data input devices such as an inventory data module 20, a barcode scanner 22, and a digital camera 24. The use of these modules to inventory a facility and layout equipment will be described with reference to FIGS. 2 through 23.

Also included in the computer network of FIG. 1 is a drafting computer 26 running an AutoCAD program 28 and connected to a facilities database 30. As illustrated, the drafting computer 26 is coupled to receive data from the inventory database 12 and is also coupled to provide data from the AutoCAD program to the web server 14. To manage the layout of a facility with the network of FIG. 1, one or more user computers 32 having a web browser 34 couples to the web server 14 of the server computer 10.

The network of FIG. 1 provides users of the user computer 32 with a visual means using pictures and words displayed within the browser 34, such as Netscape Navigator or Microsoft Internet Explorer, to describe the inventory and configuration of a facility. The network of FIG. 1 comprises interconnected computers programmed with commercial off-the-shelf software products that function to produce inventory and facilities management in accordance with the present invention.

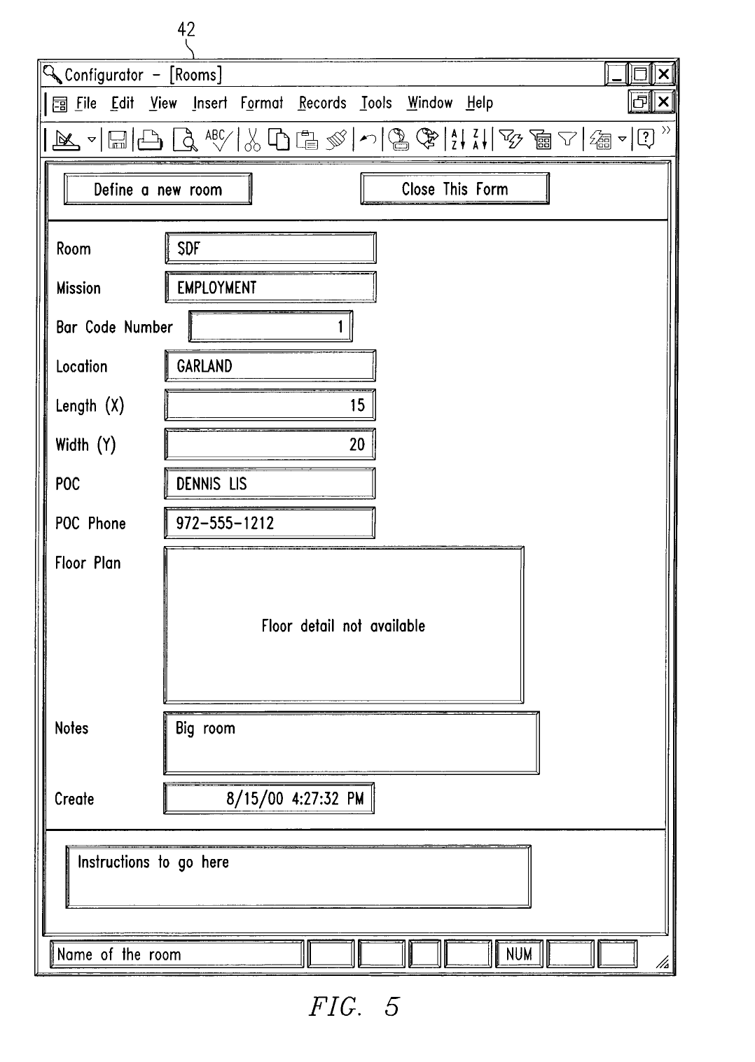

Referring to FIG. 2, to enter inventory items into the inventory database 12 or 18, the method of inventory management starts at routine 36 to create several screens, such as screen 38 of FIG. 4, to enable an inventory team or single user to enter all the data necessary to show the configuration of fixtures, equipment, equipment racks and systems (all hereinafter equipment units) along with the facilities. For this operation, the computers of FIG. 1 are programmed with database management software such as Microsoft Access and/or Visual Basic.

After starting the inventory process at routine 36, a user enters a description of the facility (room) containing the equipment units by means of a routine entitled “describe an existing facility” 40. The user points and clicks on “room definitions” of screen 38 to bring up the form of screen 42 of FIG. 5. Screen 42 prompts the user to enter data describing the existing facility and this data is stored in the facilities database 30. The screen 42 also prompts the user to enter the necessary data to describe a facility containing equipment units to be inventoried. The facilities layout is entered from the drafting computer 26 utilizing the AutoCAD program 28 as illustrated by screen 44 of FIG. 17.

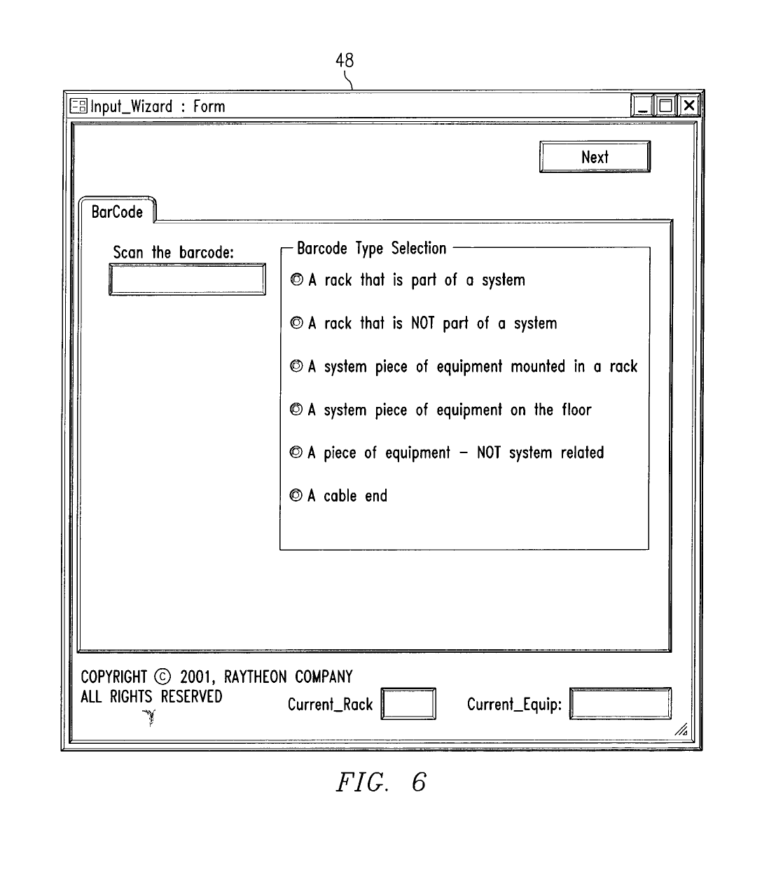

Although there is no fixed order for completing the inventory of a facility and the equipment units contained therein, the sequence illustrated in FIG. 2 proceeds from describing an existing facility 40 to assign identification to equipment, fixtures and systems 46. Barcode labels and numbers are assigned to all rooms comprising a facility, equipment, equipment racks, fixtures, systems and cables. Utilizing barcodes enables indexing of the inventory within one or more of the databases in the network of FIG. 1. A user of one of the laptop computers 16 points and clicks on display screen 48 of FIG. 6 and by means of the barcode scanner 22 scans all the barcode labels and numbers in the facility (rooms). The screen 48 prompts the user to enter the information from a scanned barcode into the correct database by pointing and clicking on one of the Barcode type selections illustrated in screen 48.

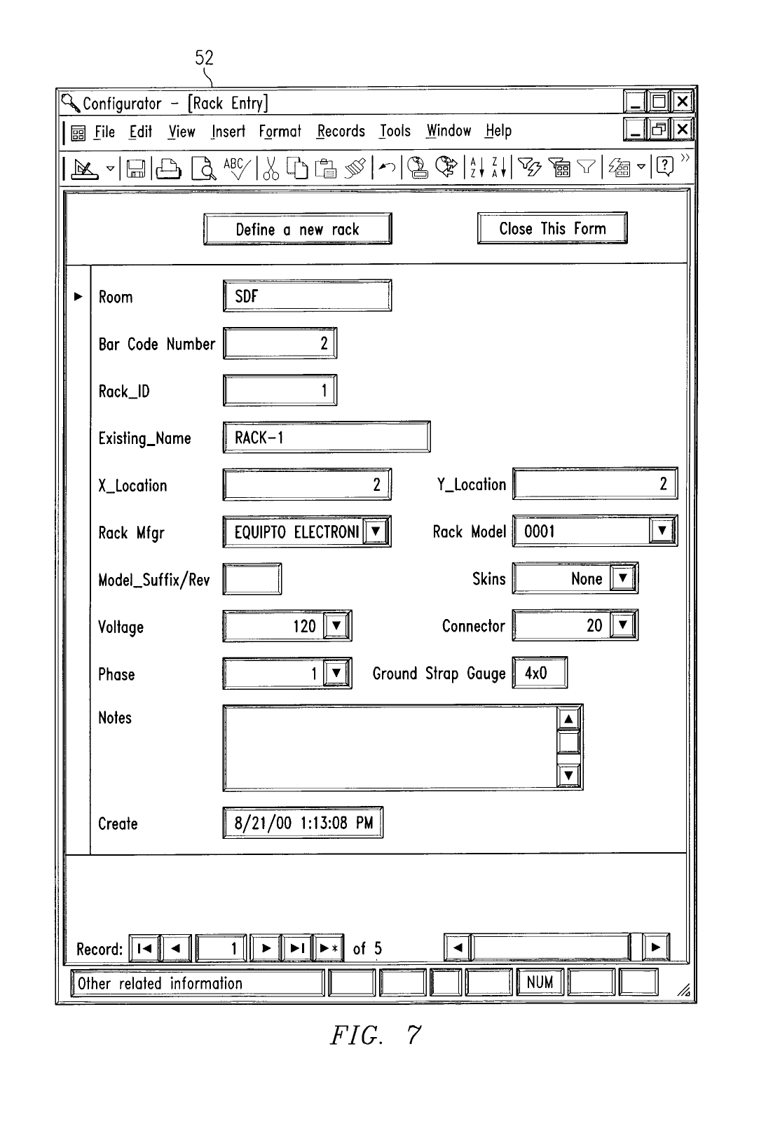

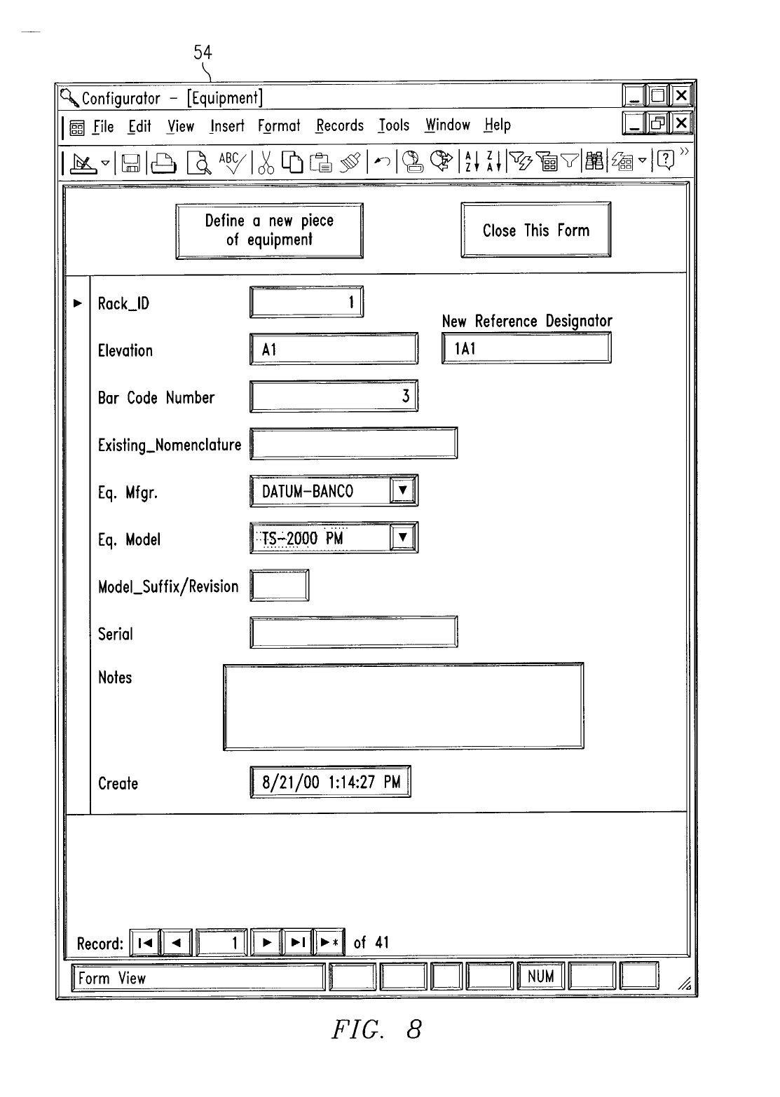

After describing an existing facility 40 and assigning identification to equipment, fixtures and systems 46, the inventory management of a facility continues by defining equipment, fixtures, systems functions, manufacturer and model 50. A user enters this part of the method of inventory management by pointing and clicking on one of the categories identified in screen 38 of FIG. 4. By pointing and clicking on rack definitions of screen 38, a user will call up screen 52 of FIG. 7 to be prompted to provide the data defining a rack including the rack manufacturer and rack model number. The user enters data to identify the room in which the rack is located by supplying the information requested on screen 52. Following definition of a rack in response to the prompts on screen 52, the data defining the identified rack is stored in one or more of the inventory databases 12, 18 of FIG. 1. This process of rack definition continues for each of the equipment racks included in an existing facility that are to be moved to another facility or for new equipment racks that are to be included in the facility under consideration for configuration management.

Following definition of all the equipment racks to be considered for installation in a facility of interest the user closes the screen 52 and returns to the screen 38 of FIG. 4. The user points and clicks on another category identified in screen 38, for example, equipment definitions. This action by a user calls up screen 54 of FIG. 8 for defining equipment to be installed either in a rack or as a standalone piece of equipment. The screen 54 prompts a user to define a piece of equipment including the equipment manufacturer and the equipment model. After all the information requested on screen 54 is input by a user, the data for the defined equipment is stored in one or more of the inventory databases 12, 18 of FIG. 1. The user then defines another piece of equipment to be installed in a rack or a standalone, again utilizing the screen 54 for prompting input of the required information for defining a piece of equipment. This process continues until all the equipment to be installed in a facility of interest has been defined and the defining data stored in one or more of the inventory databases 12, 18. The user then points and clicks to close the screen 54, and the system returns to screen 38 of FIG. 4.

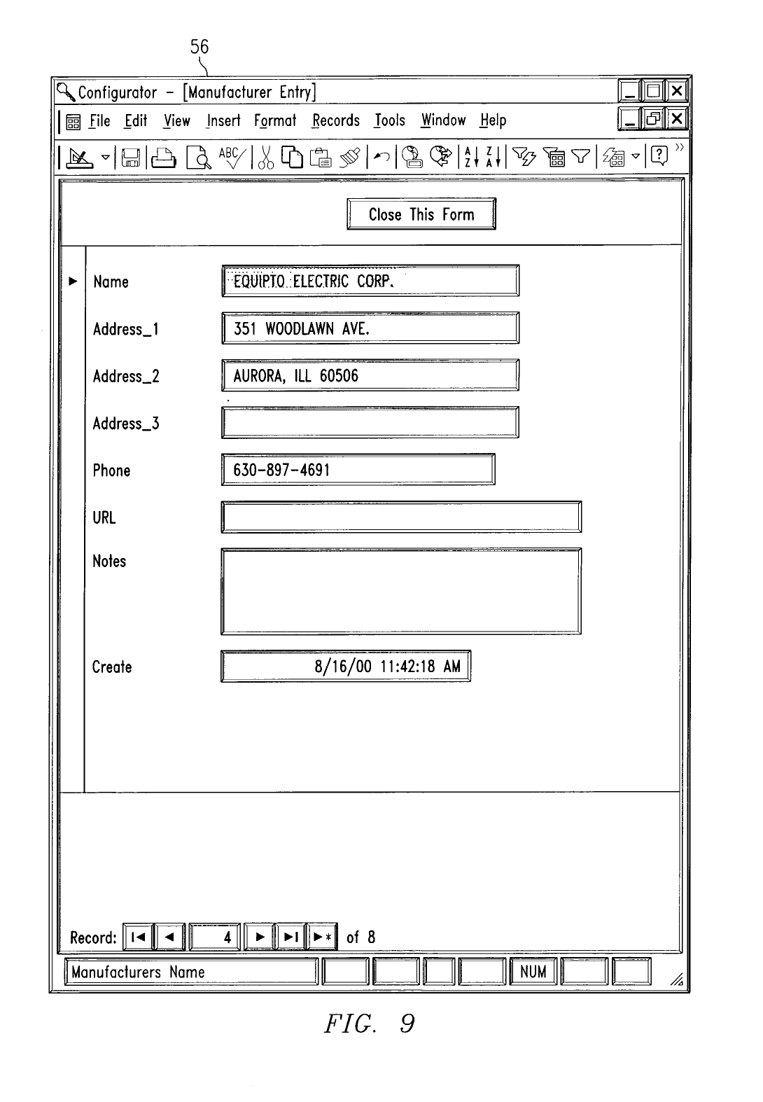

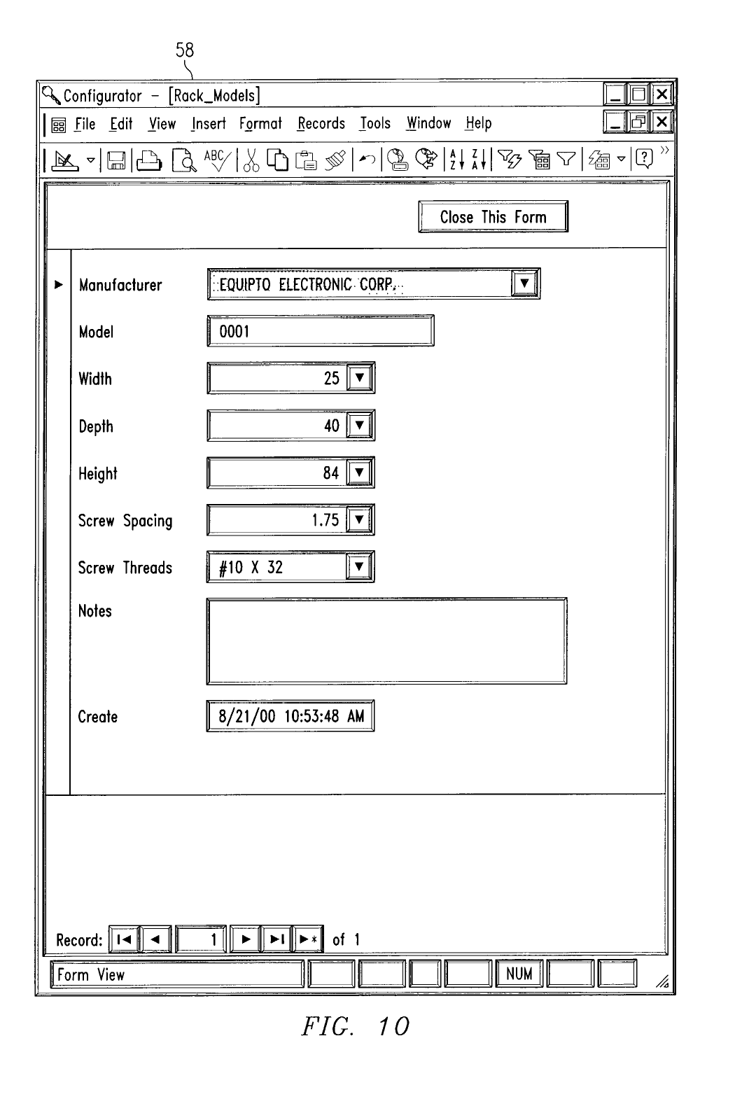

To provide the information necessary for completing a layout management, data related to manufacturer information is also stored in the inventory database 12, 18. Utilizing screen 38 of FIG. 4, the user points and clicks on manufacturers details thereby calling up screen 56 of FIG. 9. By use of the screen 56, the user is prompted to define the manufacturer of equipment as input from the screen 52 or the screen 54 of FIGS. 7 and 8, respectively. After a manufacturer is fully identified, the user transfers the manufacturer information to the inventory database 12, 18. Each manufacturer identified when defining a rack from screen 52 or defining equipment from screen 54 is input by means of screen 56. After all the manufacturers have been so identified and defined, the user closes the screen 56 thereby recalling screen 38 of FIG. 4.

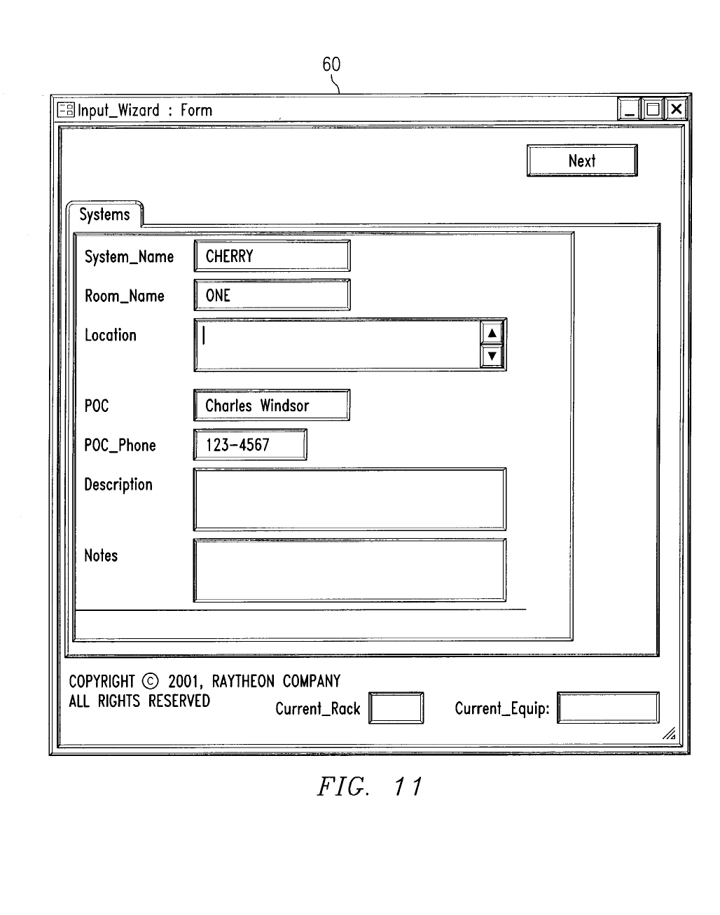

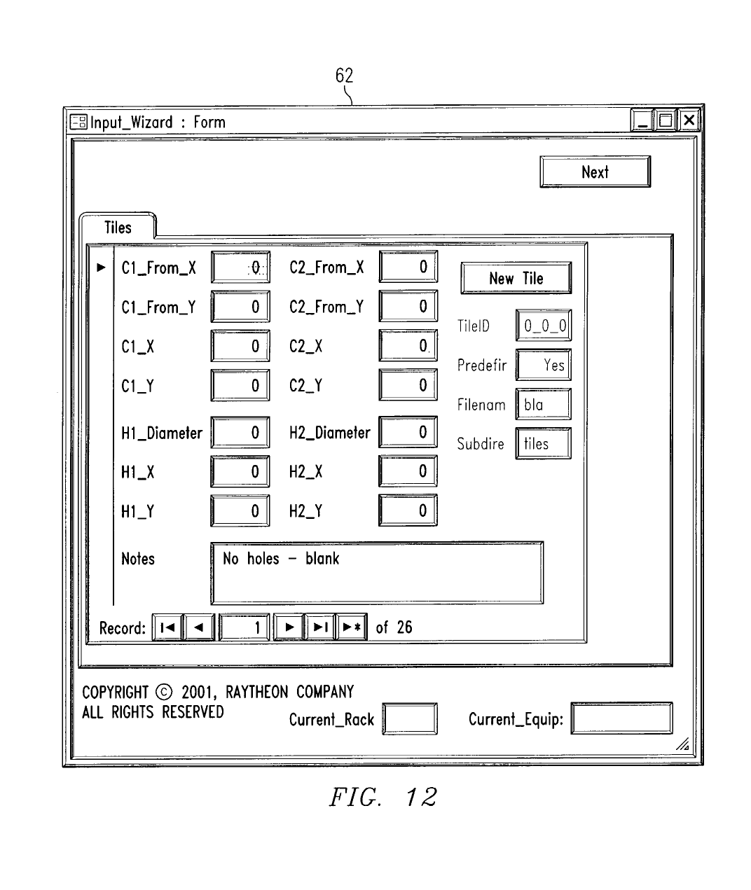

The user now points and clicks on rack models of screen 38 to display screen 58 of FIG. 10. The user now enters the model number and size and mounting specifications for a rack selected from the inventory database 12, 18. This additional information defining a rack is stored in the inventory to database 12, 18 and the user proceeds to fill out the form of screen 58 for each of the equipment racks in the inventory database 12, 18. When all the rack models have been defined, the user points and clicks to close the form of screen 58 and returns to the screen 38. The user now points and clicks on equipment details on screen 38, thereby displaying screen 60 of FIG. 11.

The inventory process of FIG. 2 continues to record equipment, fixtures and system layout 64 by means of the screen 60. The data provided in the system layout 64 by means of screen 60 is stored in the inventory database 12, 18 for each piece of equipment, fixture, and system layout. Upon completion of the recording of information by means of the screen 60, the user points and clicks on “next” and screen 62 is displayed to the user. The inventory process of FIG. 2 then advances to define the floor tiles beneath the equipment 66. By means of the form of screen 62, a user defines the dimensions and openings of floor tile beneath the equipment. The floor tile provides openings for supplying cable connections to equipment within a rack. The form of screen 62 is completed for each equipment rack to be inventoried in the database 12, 18.

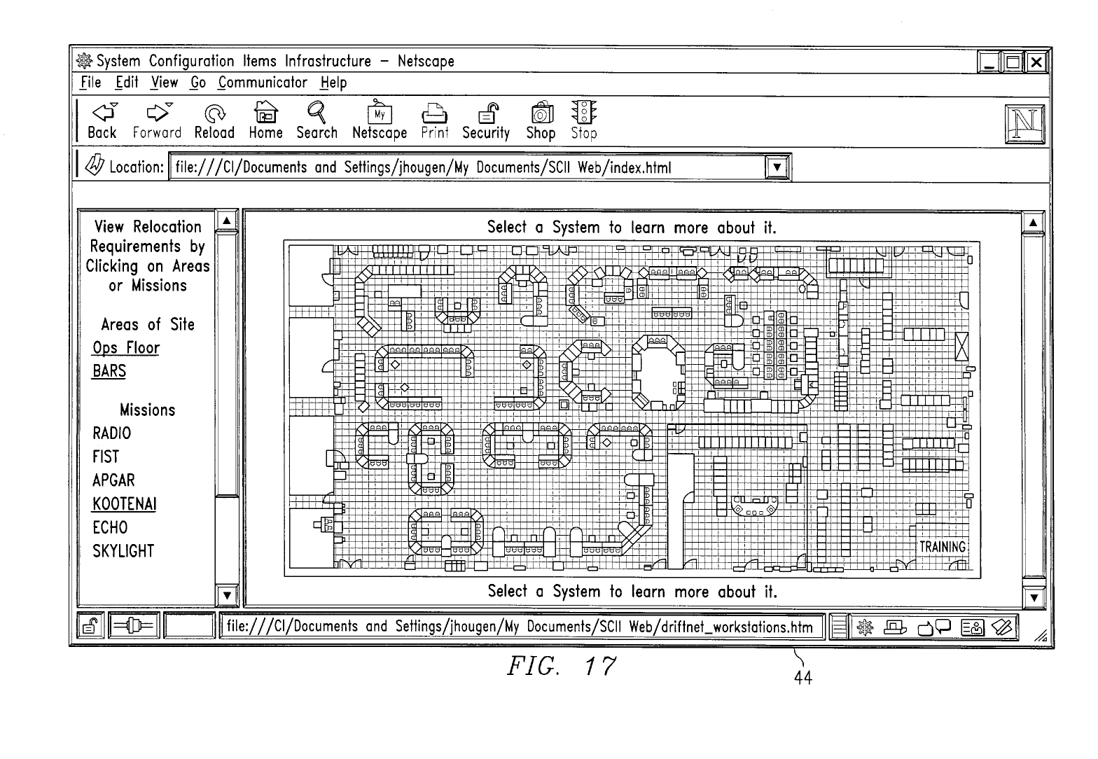

Upon completing the inventory of the equipment details and defining the floor tiles, the user returns to screen 38 of FIG. 4. To define the cables interconnecting the various equipment, fixtures, and subsystems, the user points and clicks on cable end definitions, and screen 68 of FIG. 14 is displayed. By use of the form of screen 68, the user defines cable ends for equipment to be inventoried. Following the instructions on the screen 68, the user locates the equipment that a particular cable is connected to by means of navigation buttons. The user then clicks on “next” to identify the cable ends of a piece of equipment in inventory. Having identified the equipment and clicking on “next”, screen 70 of FIG. 15 appears on a monitor for user use to provide inventory details. The user provides the information requested on the form of screen 70 for a located piece of equipment. When the form of screen 70 has been completed by a user, the data is stored in one or more inventory databases 12, 18, as illustrated in FIG. 1. Cable ends are defined for each piece of equipment in the inventory database 12, 18 of FIG. 1.

During the inventory process, the cables are bar-coded and the to/from route of each cable is defined by completing the forms of screens 68 and 70 of FIGS. 14 and 15, respectively. Referring to FIG. 16, by means of the drafting computer 26 and the AutoCAD program 28, the pinout of each cable is defined for storing in the inventory database 12, 18 as illustrated by the AutoCAD drawing of screen 74 illustrated in FIG. 16. In addition to the pinout of each cable defined for storing in the inventory database 12, 18 image of the drawing that illustrates the cable and associated pinouts is selected from the browser as illustrated in FIG. 16.

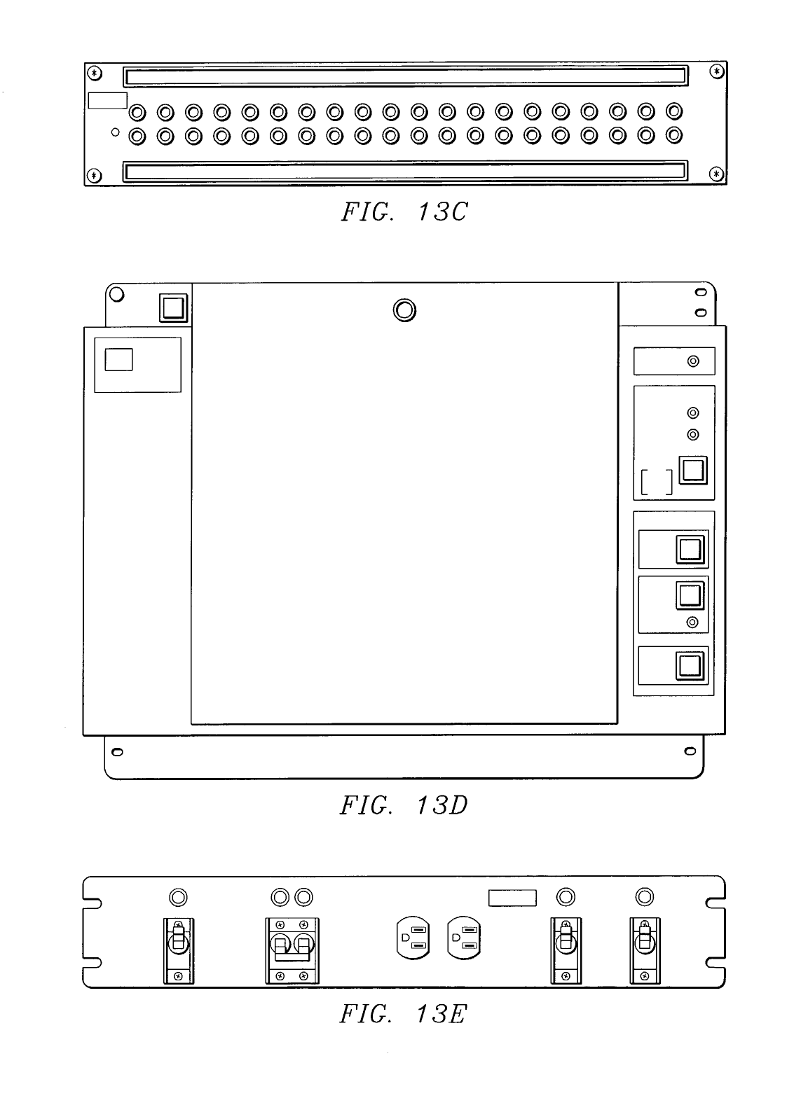

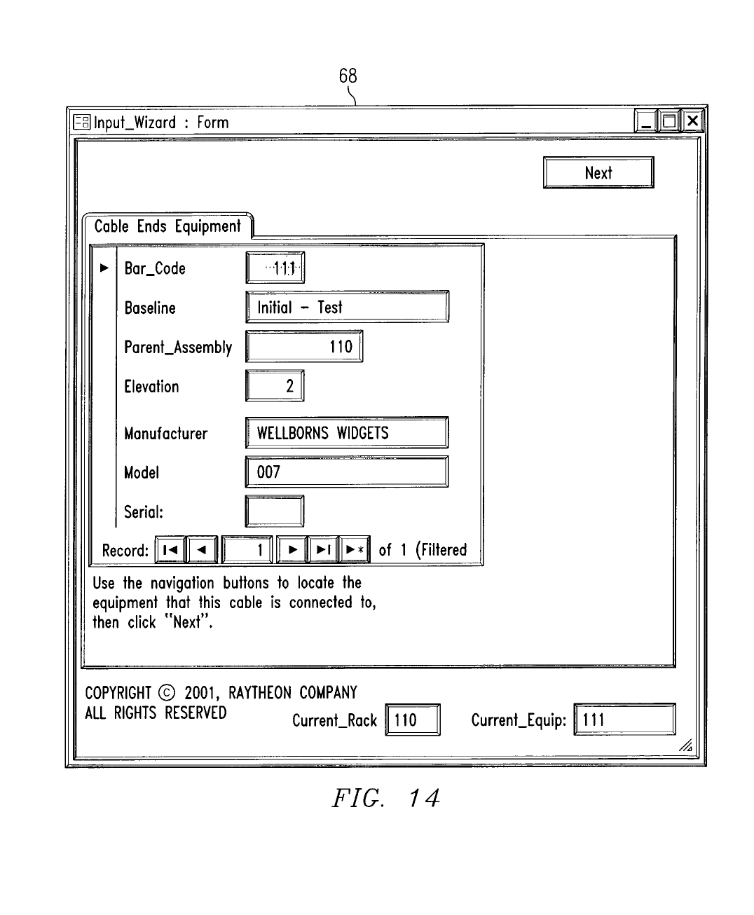

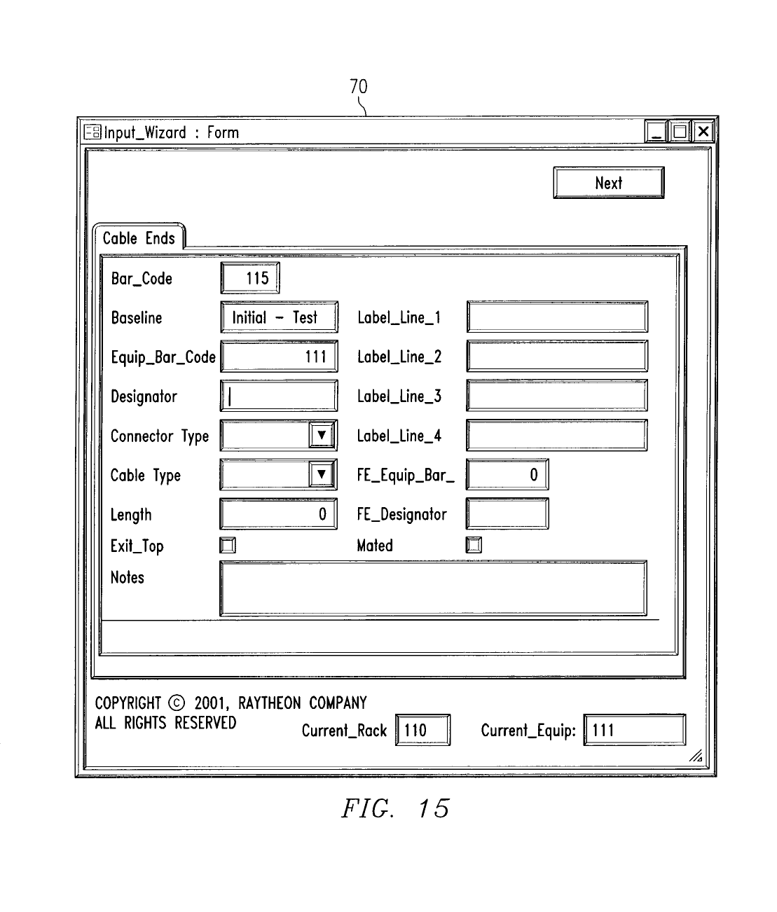

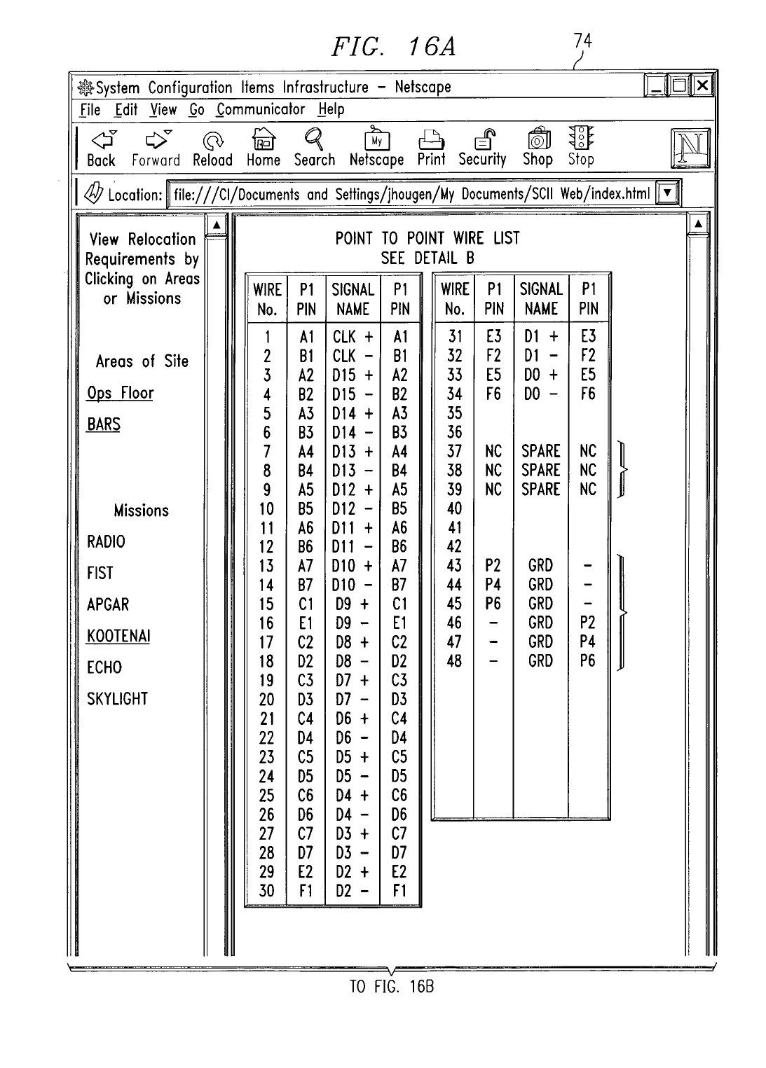

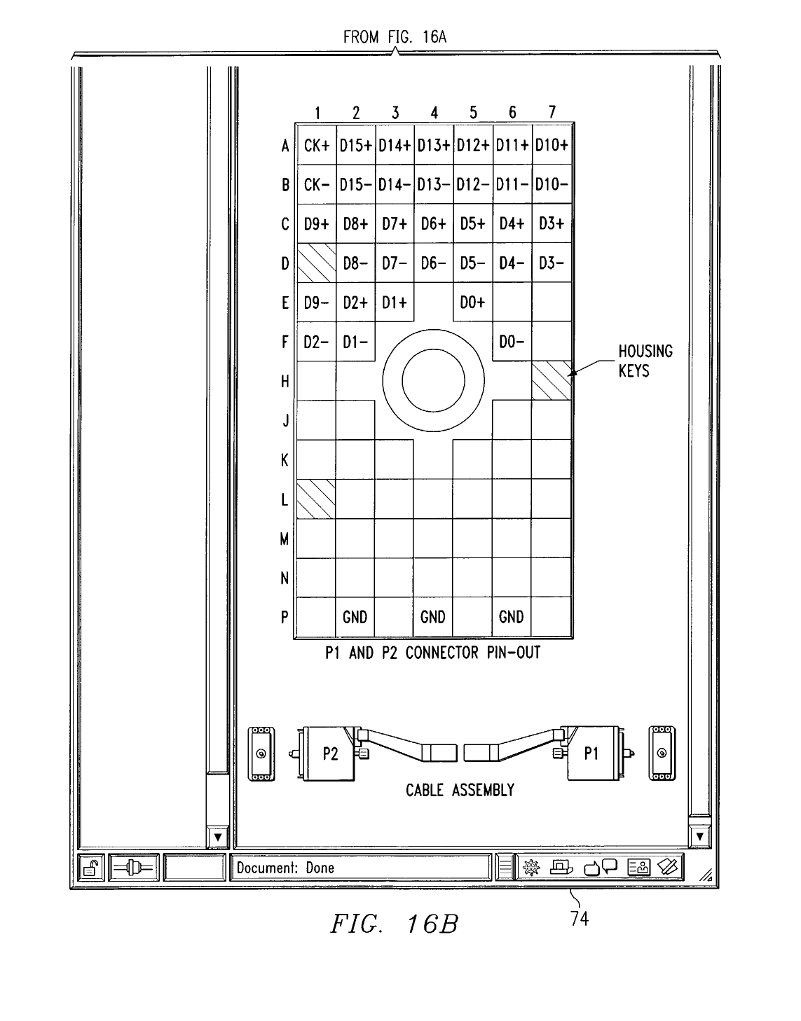

Also forming a part of the inventory process of FIG. 2 is the input of digital photographs of the equipment taken by means of the digital camera 24. Various digital photographs of equipment to be inventoried is illustrated in FIGS. 13a through 13e. The photographs are edited to enable fitting within specifications showing an accurate representation of the piece of equipment in height and width. This enables the visual reconstruction of a rack when a user recalls from the inventory database an image of a rack.

The data input to the system of FIG. 1 by means of the various screens is stored in one or more databases during the routine 72, thereby completing the inventory of equipment fixtures, systems and equipment racks for an existing facility.

When the inventory of the fixtures, equipment, equipment racks and systems is complete, the inventory data resides in several forms such as an Oracle database, separate digital photographs, separate AutoCAD drawings on various servers or one server, or in a web-enabled format anywhere connected to the network of FIG. 1. A server script code enables a browser user to query the various data sources and to use other commercially available browser plug-ins to display the desired inventory data.

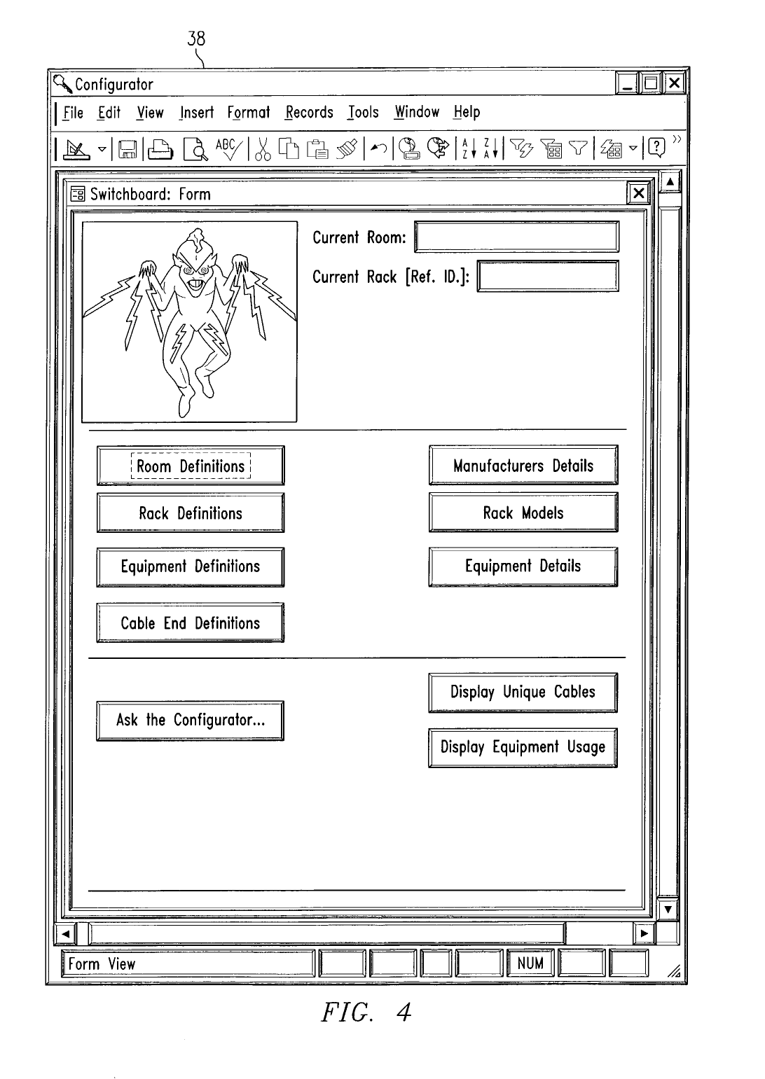

Referring to FIG. 3, a typical layout session starts at 76, and a graphical map of a facility of interest is displayed on a computer monitor during sequence 78. A user brings up a browser on a PC or workstation, such as the laptop computer 16 of FIG. 1 anywhere on the network. At 78, the user views a facility to be queried either with linked words or a floor plan view depicting the location of various systems and equipment as shown by screen 44 of FIG. 17. The user selects the next level of detail for the graphical map of the facility of interest at 80 by either clicking with a pointing device on a linked word or on the floor plan to go to the next level of detail for this system to obtain more information on a system of interest.

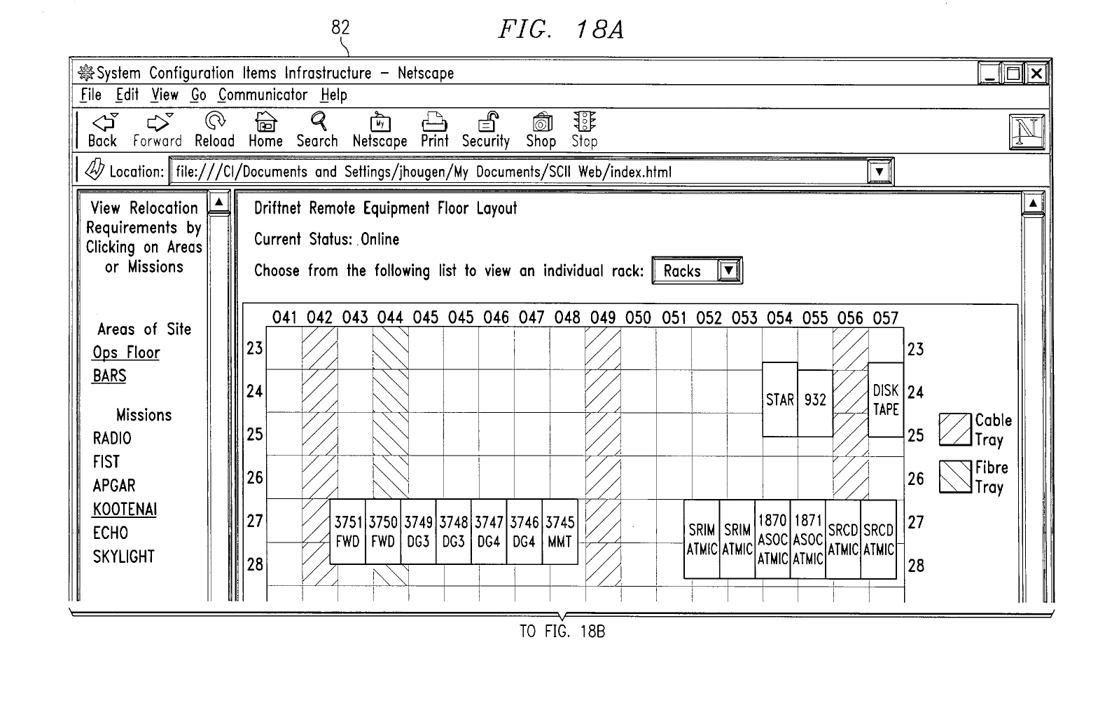

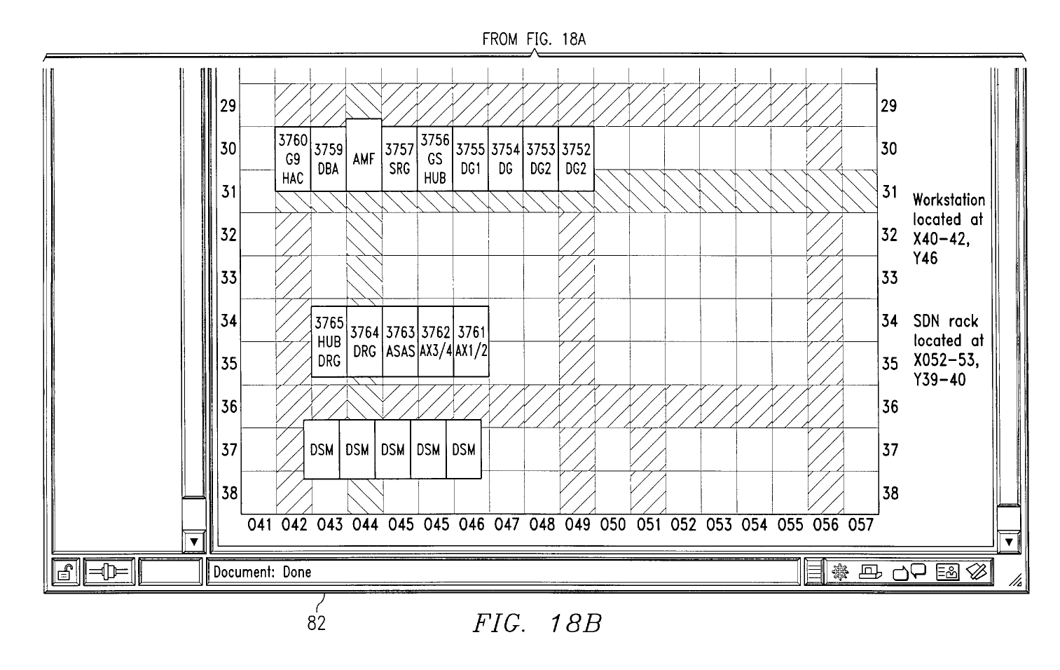

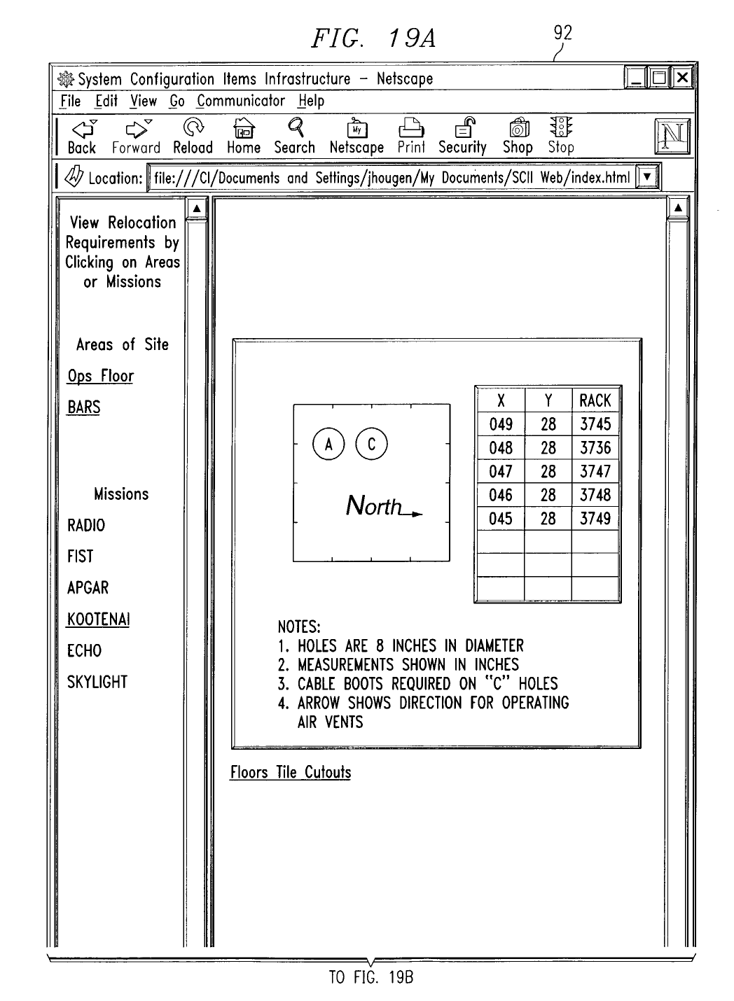

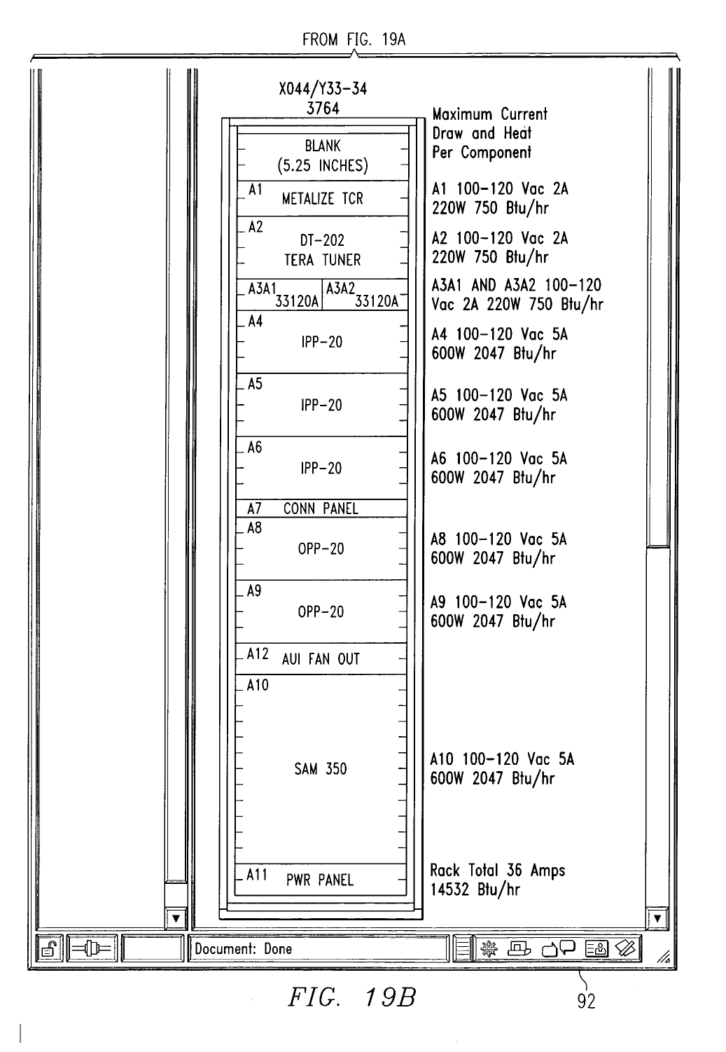

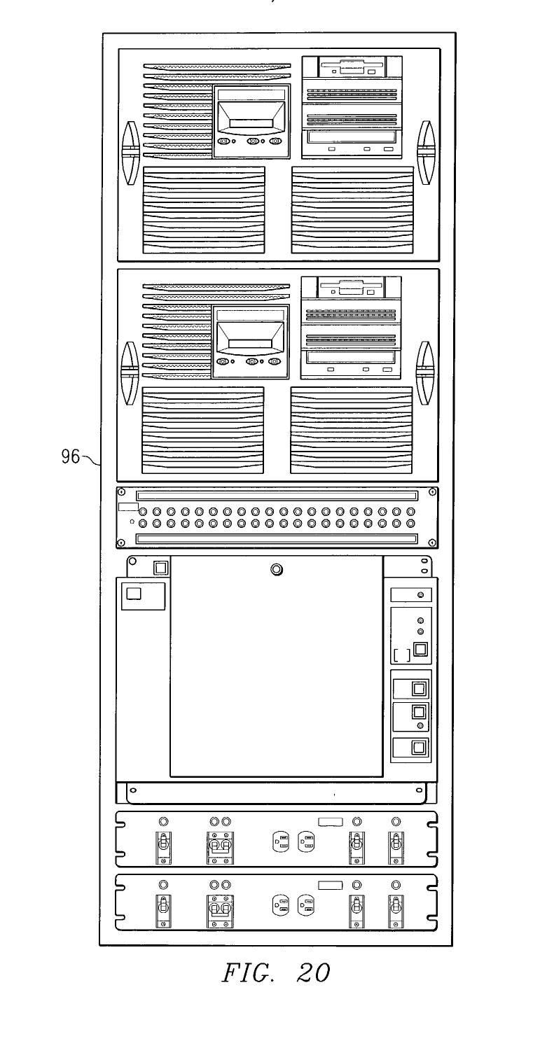

The next level, as illustrated by screen 82 of FIG. 18, shows a user a system of interest allowing visualization of rack numbers, floor locations and cable trays located below the floor of the facility of interest. A measuring tool built into the system allows a user to measure the distance between racks for the purpose of designing new cables or laying out the room for new equipment. By clicking on various options in the form of screen 82, the user chooses from a list of individual racks for viewing details of a selected rack. Thus, by means of the screen 44 of FIG. 17 and the screen 82 of FIG. 18, a user selects past, present, or a future configuration for the graphical map of the facility of interest at 84 and then proceeds to select an equipment rack from the graphical map of the facility of interest at 86. By clicking on “racks” of screen 82, there is displayed on a computer monitor a synthesized illustration of the selected equipment rack at 88. At this point, a user selects a rack from the floor layout to observe more detail of the selected rack. The selected rack is illustrated by screen 92 of FIG. 19. Details of the floor tile beneath the selected equipment rack are also displayed on the computer monitor at 94, again as illustrated in FIG. 19. The system also generates the rack elevation picture 96 of FIG. 20 from individual photos of equipment taken by the digital camera 24 and data stored in the inventory database 12, 18. Also, as illustrated on screen 92 of FIG. 19, the power consumption, weight, and heat output based on components in the equipment rack are calculated and displayed. Additional parameters are available for display as selected by a user.

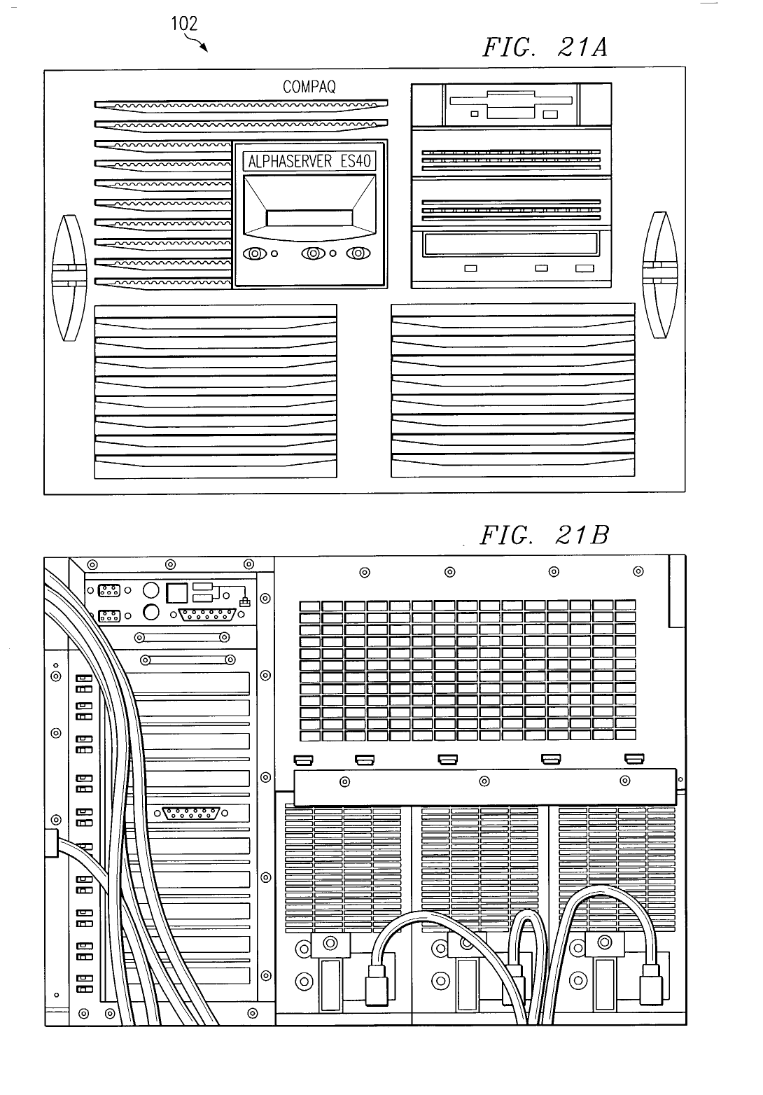

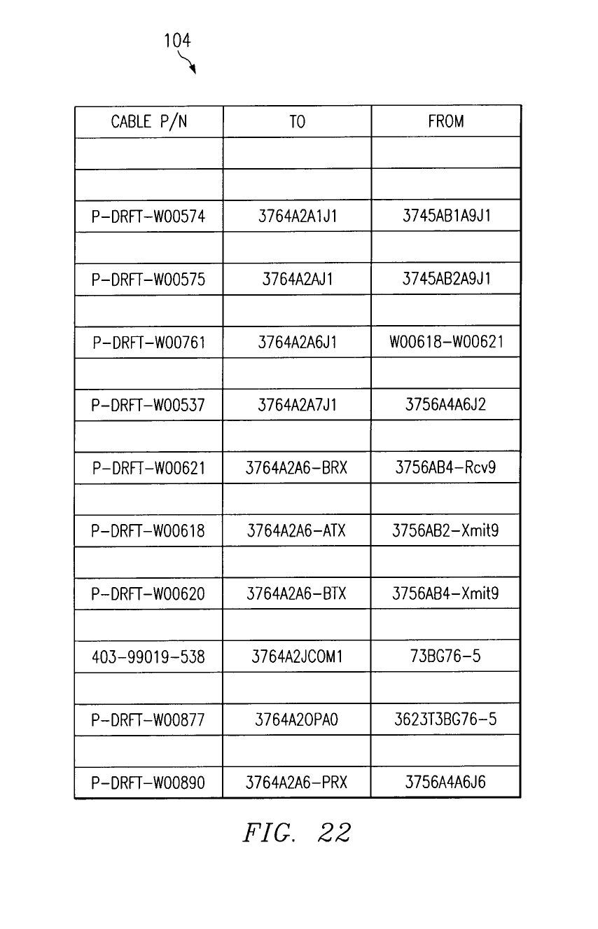

Referring again to FIG. 3, viewing a layout of a facility of interest a user displays on a computer monitor details of the interconnecting cables associated with selected equipment units at 98. Also displayed on a computer monitor at 100 is online documentation associated with the selected equipment unit. When a user wants more information on a particular piece of equipment in a rack, the user, utilizing screen 92 of FIG. 19, points and clicks on the specific piece of equipment of interest. There will then be displayed on a separate page details of that piece of equipment and more links to more detailed information such as illustrated in FIG. 21. FIG. 21 illustrates the front view details of equipment model ES40 and also the rearview of the same equipment model. In addition, displayed to the user, by screen 102 of FIG. 21 is the rack identification number, elevation, barcode number, manufacturer, model, serial number, and any notes made during the inventory process. In addition, screen 102 of FIG. 21 displays links if more information is needed. For example, a user would point and click on the link “user guide” or “installation guide”, both provided by the manufacturer. By clicking on “cables connected to,” the user has available by means of the display 104 of FIG. 22 a cable to/from list extracted from the inventory database 12, 18.

A user selects an individual equipment unit from the synthesized illustrations of a selected equipment rack at 106. A user displays on a computer monitor photographs of the selected equipment at 108. Also displayed on a computer monitor are details of the selected equipment unit at 110. As illustrated by screen 104 of FIG. 22, the user also displays on a computer monitor details of interconnecting cables associated with the selected equipment unit at 112. By pointing and clicking on various categories of information as illustrated by screen 102 of FIG. 21, a user is able to display on a computer monitor online documentation associated with selected equipment units at 114. Finally, to complete the layout process, a user displays on a computer monitor other locations of selected equipment unit at 116.

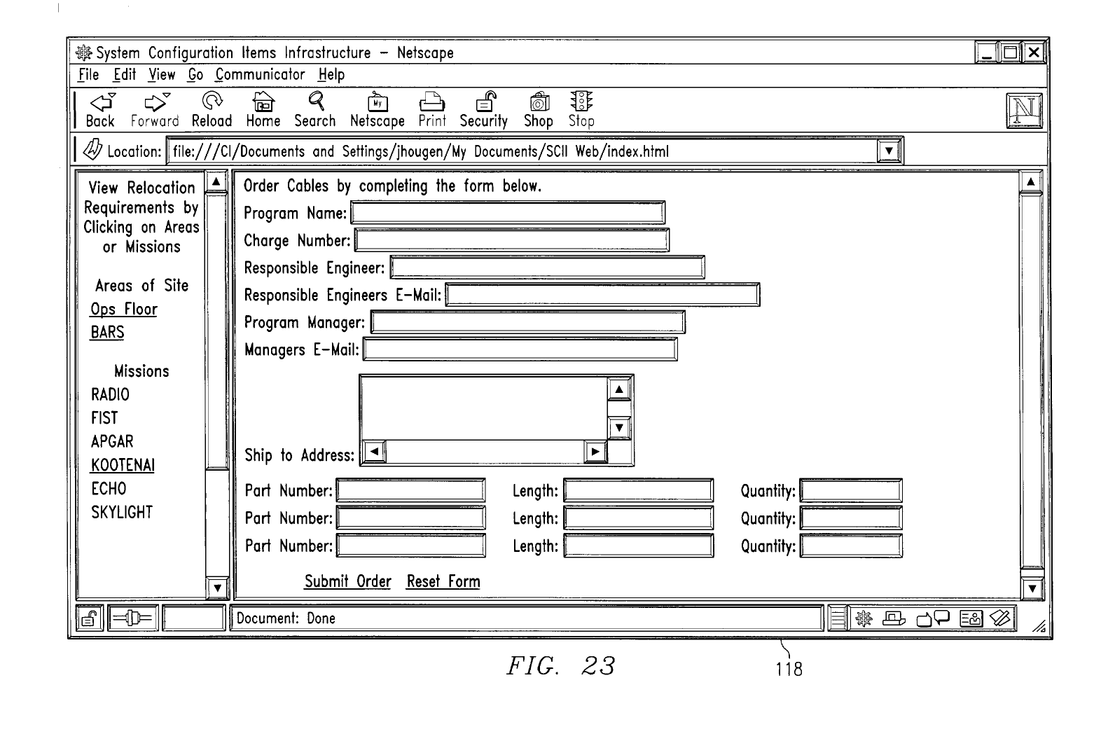

Also available to the user in laying out a facility of interest is an online order form as illustrated by screen 118 of FIG. 23. The order can be routed through the network to receive electronic signatures and sent to purchasing to put the parts on order.

Although the present invention has been described with reference to detailed embodiments, various changes and modifications may be suggested to one skilled in the art. It is intended that the present invention encompass such changes and modifications that fall within the scope of the appended claims.

What is claimed is:

1. A method for generating inventory data for a facility, fixtures, equipment, equipment racks, and systems, comprising:
creating a database of information defining a facility and the layout of any fixtures, equipment, equipment racks, and systems;
creating a database of information defining any of the fixtures, equipment, equipment racks, and systems in the facility;
assigning identification information to the defined fixtures, equipment, equipment racks and systems to create an identification database; and
storing the created databases in one or more memory locations of a computer network.

2. The method as in claim 1 further comprising creating a database of information defining the details of any fixtures, equipment, equipment racks and systems in the defined facility; and
storing the created database in one or more memory locations of the computer network.

3. The method as in claim 1 further comprising creating a database of information defining floor tiles for supporting any fixtures, equipment, equipment racks and systems in the defined facility; and
storing the floor tile database in one or more memory locations of the computer network.

4. The method as in claim 1 wherein creating a database of information defining the facility comprises defining links to relevant documents related to the fixtures, equipment, equipment racks and systems.

5. The method as in claim 1 wherein assigning identification information comprises attaching barcode labels to the fixtures, equipment, equipment racks and systems and scanning the barcodes to create the identification database.

6. The method as in claim 1 wherein creating a database of information defining any fixtures, equipment, equipment racks and systems comprises defining equipment mounted in the defined racks as a part of the database of information.

7. The method as in claim 6 wherein creating a database of information defining any fixtures, equipment, equipment racks and systems further comprises creating a database of information defining the manufacturer of any fixtures, equipment, equipment racks and systems.

8. A method for generating inventory data for a facility, fixtures, equipment, equipment racks and systems, comprising:
creating a database of information defining a facility and the layout of any fixtures, equipment, equipment racks and systems;
creating a database of information defining any of the fixtures, equipment, equipment racks and systems in the facility;
assigning identification information to the defined fixtures, equipment, equipment racks and systems to create an identification database;
creating a database of information defining the details of any fixtures, equipment, equipment racks and systems in the defined facility;
creating a database of information defining the floor tiles for supporting any fixtures, equipment, equipment racks and systems in the defined facility; and
storing the created databases in one or more memory locations of a computer network.

9. The method as in claim 8 wherein creating a database of information defining any of the fixtures, equipment, equipment racks and systems in the facility comprises creating photographs of the fixtures, equipment, equipment racks and systems as part of the created database of information; and
scanning the created photographs into a database of the computer network.

10. The method as in claim 8 wherein assigning identification information comprises attaching barcode labels to the fixtures, equipment, equipment racks and systems; and
scanning the barcode to create the identification database.

11. The method of claim 8 wherein creating a database of information defining any fixtures, equipment, equipment racks and systems comprises creating a database of information defining equipment mounted in the defined equipment racks as a part of the database of information.

12. The method as in claim 11 wherein creating a database of information defining any fixtures, equipment, equipment racks and systems further comprises defining the manufacturer of any fixtures, equipment, equipment racks and systems.

13. A method for managing the configuration of a facility layout, comprising:
creating one or more databases defining the facility, fixtures, equipment, equipment racks and systems;
visualizing a facility for configuration management utilizing the created one or more databases;
selecting from the one or more databases fixtures, equipment, equipment racks and systems for managing the layout configuration of the visualized facility; and
illustrating the fixtures, equipment, equipment racks and systems in a layout configuration in the visualized facility selected from the created one or more databases.

14. The method as in claim 13 wherein illustrating the fixtures, equipment, equipment racks and systems further comprises selecting the level of detail for illustration of the fixtures, equipment, equipment racks and systems from the created one or more databases.

15. The method as in claim 14 further comprising illustrating the selected level of detail of the selected fixtures, equipment, equipment racks and systems.

16. The method as in claim 13 further comprising positioning one or more of the selected fixtures, equipment, equipment racks and systems in the visualized facility for layout management.

17. The method as in claim 13 wherein selecting fixtures, equipment, equipment racks and systems comprises selecting equipment for installation in equipment racks for positioning in the visualized facility for managing the layout configuration.

18. The method as in claim 17 further comprising calculating the distance between equipment racks to layout the selected racks in the visualized facility for managing the layout configuration.

19. The method as in claim 17 further comprising calculating the power consumption, weight, and heat output based on equipment selected for installation in the selected equipment racks.

20. The method as in claim 17 further comprising generating a rack elevation view illustration for equipment in selected equipment racks.

21. The method as in claim 13 further comprising defining a new equipment rack for equipment defined in a database of equipment information.

22. The method as in claim 17 further comprising defining additional equipment for assembly in a selected equipment rack or as a standalone piece of equipment in the visualized facility.

23. A method for managing the configuration of a facility layout, comprising:
creating one or more databases defining the facility, fixtures, equipment, equipment racks and systems;
visualizing a facility to be configured utilizing one or more of the created databases;
selecting from the one or more databases fixtures, equipment, equipment racks and systems for installation in a visualized facility for layout management;
illustrating the fixtures, equipment, equipment racks and systems selected from the created one or more databases for visualizing a layout management in the visualized facility;
defining floor tile for supporting equipment racks and providing cable access to equipment supported in the equipment racks;
defining the cable ends for fixtures, equipment, equipment racks and systems illustrated in the visualized facility; and
illustrating a fixture, equipment, equipment rack and system floor layout of a visualized facility detailing interconnecting trays.

24. The method as in claim 23 further comprising generating a connecting cable to/from list for selected fixtures, equipment, equipment racks and systems for the illustrated equipment floor layout.
